(19) United States
(12) Patent Application Publication
(10) Pub. No.: US 2003/0121956 A1
(43) Pub. Date: Jul. 3, 2003

(54) Apparatus and method for corrosion resistant cladding

(75) Inventors: Henry P. Offer, Los Gatos, CA (US); Eric R. Willis, San Jose, CA (US); Paul van Diemen, San Jose, CA (US); Steven J. Kaylor, San Jose, CA (US)

Correspondence Address: NIXON & VANDERHYE P.C., 8th Floor, 1100 North Glebe Road, Arlington, VA, 22201-4714, US

(73) Assignee: General Electric Company

(21) Appl. No.: 10/051,057

(22) Filed: Jan. 22, 2002

Related U.S. Application Data
(63) Continuation of application No. 09/416,943, filed on Oct. 13, 1999, now abandoned.
(60) Provisional application No. 60/104,022, filed on Oct. 13, 1998.

(51) Int. Cl. B23K 1/20

(52) U.S. Cl. 228/214

(57) ABSTRACT

Method of welding cladding to a surface of a metal component of a nuclear reactor at a region susceptible to stress corrosion cracking, in which the metal is welded to the surface of the component under conditions of low heat input to achieve reduced thermal sensitization at the edges of and within the newly clad region.

### FIELD OF THE INVENTION

The invention relates to the welding of cladding on structural steels with significantly improved resistance to stress corrosion cracking. In particular, the invention relates to the welding of cladding on structural steels employed in nuclear reactors, which structural steels are susceptible to stress corrosion cracking in heat affected zones adjacent to a weld, or in cold-worked material.

### BACKGROUND OF THE INVENTION

A nuclear reactor contains a core of fissionable fuel which generates heat during fission. The heat is removed from the fuel core by the reactor coolant, i.e., water, which is contained in a reactor pressure vessel. Piping circuits carry the heated water or steam to the steam generators or turbines and carry circulated water or feed water back to the vessel. Operating pressures and temperatures for the reactor pressure vessel are about 7 MPa and 288° C. for a boiling water reactor (BWR), and about 15 MPa and 320° C. for a pressurized water reactor (PWR). The materials employed in both BWRs and PWRs must withstand various loading, environmental and radiation conditions. As used herein, the term “high-temperature water” means water having a temperature of about 150° C. or greater, steam, or the condensate thereof.

Materials exposed to high-temperature water include, for example, carbon steel, alloy steel, stainless steel, and nickel-based, cobalt-based and zirconium-based alloys. Despite careful selection and treatment of these materials for use in water reactors, corrosion occurs on the materials exposed to the high-temperature water. Such corrosion contributes to a variety of problems, e.g., stress corrosion cracking (SCC), crevice corrosion, erosion corrosion, sticking of pressure relief valves and build-up of the gamma radiation-emitting Co-60 isotope.

Stress corrosion cracking (SCC) has been a problem affecting the operational availability of boiling water reactor (BWR) power plants for a number of decades. The problem arises when a combination of sensitized material, tensile stresses, and high-temperature oxygenated water exists during service. One common form of sensitization is caused by the thermal cycle of welding, where the weld bead cooling sequence is sufficiently slow to allow precipitation of chromium carbides at the microstructural grain boundaries. This precipitation of carbides depletes the adjacent grain boundary regions of chromium to an extent that they are no longer corrosion resistant. Hence, SCC can occur at these boundaries in otherwise corrosion-resistant materials when in the presence of a chemically aggressive water environment and a sufficiently high surface tensile stress.

Many of the older reactor plants were inadvertently constructed with higher carbon stainless steel, which was thermally sensitized during fabrication heat treatment or weld joining processes. In addition, the welding practices typically used high heat inputs which were sufficient to lead to tensile residual stresses and the corresponding SCC failures. Repair or replacement of these components is generally very expensive due to the fact that operating plants must be shut down for longer outages to perform major replacements, and due to the high levels of radioactive contamination on the internal surfaces (or activation within the volume) of the plant components.

Past efforts to develop corrosion-resistant weld cladding to be deposited over sensitized regions were designed for use in fluid process piping, typically of 4-inch nominal diameter or greater. For these sizes, multiple layers were possible to compensate for dilution of the deposit chromium content by the base material, since their total thickness was not critical.

A number of solutions to the problem of SCC have been proposed over the years, including component material replacement, residual stress reduction, and water chemistry controls (or combinations of these proposals). Another approach is to electric arc weld clad over a previously sensitized region, effectively isolating it from the aggressive water environment; however, this existing method typically does not have universal applicability, since for highly susceptible substrates, existing welding methods can sensitize the edges of the newly clad region. The net effect is to cover an older SCC problem, which only generates the risk of a similar new problem nearby. Due to the high heat input of this cladding process, the edges of the clad regions may also be put into an adverse state of high surface tensile stress. In addition, this conventional method may lead to distortion of the component being clad, thereby adversely affecting the fit and/or function of interfacing components.

A further approach is laser fusion of a pre-applied, corrosion-resistant paste over an SCC-susceptible region. However, this process is tedious and highly complex, and expensive when applied remotely to in-vessel components.

Another known process is Gas Tungsten Arc (GTA) fusion of a preplaced sleeve made of corrosion-resistant material. This process however is limited to applications having a geometrically regular surface shape (such as cylindrical) to which the sleeve can be readily preshaped for adequate fit. Many sensitized areas needing to be clad are the heat-affected zones (HAZs) of joining welds, which rarely have regular or smooth surfaces. Other adverse material conditions such as furnace-sensitized, irradiation-sensitized, or cold-worked materials are also in need of a very low heat input corrosion-resistant cladding to prevent SCC.

Existing low heat-input cladding processes were qualified based on application on materials subject to sensitization, and then testing the SCC performance of the component or sample under simulated or accelerated-life plant conditions. A factor of improvement (life of a clad specimen relative to this life of an otherwise identical but unclad control specimen) was shown as the benefit of the process. This concept allows some degree of sensitization to be present, as long as the adjacent chromium-depleted layer was above the minimum for corrosion resistance for the reduced duration of the test (relative to full plant design life). To this extent, the qualification of the cladding is not as conservative as one for which no sensitization at all is allowed at the exposed surface, even on high-carbon materials, especially those with low compositional purity containing other elements which cause grain boundary sensitization.

A need exists to deposit claddings in 2-inch OD, ¼ inch wall tubing through which a closely fitting instrument must pass after cladding, with little or no ID presizing subsequent ID resizing. As a result, an extremely thin reduced heat-input cladding must be deposited as a single layer, and this single layer must tolerate dilution to have acceptable SCC resistance. The present invention seeks to satisfy that need.

### BRIEF SUMMARY OF THE INVENTION

The present invention provides a significantly improved method for weld cladding of regions susceptible to SCC that provides additional protection to both the clad area itself, as well as the adjacent unclad zone. The invention provides a high-speed wire-feed gas tungsten arc (GTA) method utilizing a very low heat input during the thin cladding process, which prevents the occurrence of thermal sensitization of the edges of the newly-clad region, even when applied to materials having a high potential for sensitization (e.g., high carbon, austenitic stainless steel (SS)). Without this capability, the sensitized material condition is only relocated (or diminished) but not eliminated at the material surface exposed to the water environment. The method of the invention combines electric arc welding parameters with improved melting kinetics and a correspondingly reduced heat input so that damaging thermal sensitization does not occur in the cladding heat-affected zone (HAZ). As used herein, the term “cladding” includes both inlay and overlay geometries. It was discovered that the disclosed cladding could be applied to high carbon SS without any surface sensitization.

According to a first aspect, the invention provides a method of joining a first metal such as cladding to a surface of a second metal such as a component of a nuclear reactor at a region susceptible to stress corrosion cracking, in which the first metal is welded to the surface of the second metal under conditions of low heat input to achieve reduced or no thermal sensitization at the edges of the newly clad region.

In another aspect, the invention provides an apparatus for remotely applying cladding to the inside surface of a tube (or pipe), at a significant distance from the end of the tube. This apparatus has the ability to provide a very stable arc voltage (and corresponding arc length control) even though the torch is positioned far from the welding head drive mechanisms. According to one aspect, the apparatus includes a rotating wire feeder which produces a wire pool very far downstream of the distal end of the wire feeder. Weldability at very low, yet stable, wire feed rates is therefore improved, enabling very thin cladding to be reliably deposited.

In addition to the benefits of a corrosion-resistant cladding layer, the cladding method of the invention provides a unique means of structurally reinforcing the surface of a component. The method may be used to repair power plant components without the resulting thermal damage in the component (e.g., shrinkage distortion or helium-induced hot cracking), which occurs when conventional, higher heat-input weld cladding processes are applied. When used for structural repairs or improvements, the method can be applied in one or more layers, as required, to yield the necessary cladding thickness and corresponding structural margins. Likewise, when applied as a corrosion-resistant cladding, the method can be applied as one or more layers (space permitting), as required, to yield the needed anti-corrosion properties.

The cladding method of the present invention overcomes the thermal-sensitization limitation of conventional, increased wire-input wire-fed TIG cladding when applied to medium or high-carbon containing SS. The method also avoids the extensive equipment costs of laser paste-fed (or wire-fed) cladding, and the limited-geometry restrictions of sleeves installed with TIG welding.

### BRIEF DESCRIPTION OF THE DRAWINGS

The invention will now be described in more detail with reference to the accompanying drawings, in which:

FIG. 1 is a representation of average wire feed rate versus heat input in relation to Heat Box 1, 2 and 3;

FIGS. 2A, 2B and 2C illustrate cross-sectional side elevations of mock-ups of various monitor housing and vessel penetration configurations used for noble metal cladding process development;

FIGS. 3A-3D illustrate a noble metal cladding process applied to wall-thickness structural repair of a vessel penetration;

FIGS. 4A-4C are schematic views showing application of the process of the present invention through a vessel penetration;

FIG. 5 is a schematic of a weld cladding system showing individual components and mounting of a cladding tool in relation to an under-vessel penetration;

FIG. 6 is a cutaway view of a welding system installed for under-vessel application of the cladding methodology of the present invention;

FIG. 7 is a schematic layout for successive cladding repairs showing the method used to prevent process fluid exposure to multiple heat-affected zones;

FIGS. 8A and 8B are micrographs comparing Ferrite size and distribution for noble metal cladding with Type 316L+1 Pd filler; 800×magnification (8A—mechanized ICMH cladding; 8B—manual cladding);

FIGS. 9A and 9B are micrographs comparing Ferrite size and distribution for noble metal cladding with Type 308L+1 Pd filler; 800×magnification (9A—mechanized ICMH cladding; 9B—manual cladding);

FIGS. 10A-10C are stress plots respectively showing ID/OD residual stress (clad), ID residual stress (no clad) and ID residual stress (clad) as a function of the distance from the J-weld wet fusion line (mm).

### DETAILED DESCRIPTION OF THE INVENTION

In one embodiment, the method of the invention uses a filler material comprised of nickel-base alloys or iron-base stainless steels such as Inconel 82, Stainless 308L or Stainless 316L, and a low concentration of a noble metal element (e.g., palladium, platinum, rhodium, or combinations thereof) to act as a catalyst for improved recombination rates of oxygen with hydrogen, at reduced hydrogen addition levels. The concentration of noble metal in the filler material is typically in the region of about 1% by weight or less, more usually about 0.25 to 0.75% by weight after dilution by base metal. Recombination of the oxygen and hydrogen peroxide with hydrogen reduces the effective electrochemical potential, in order to reduce the susceptibility to SCC. SCC.

In another aspect, the method of the invention is applied to a near surface of a substrate which is protected from SCC by virtue of the corrosion-resistant cladding alone (without the catalytic benefit of noble metal), where the far surface of the substrate is in a liquid environment, such as water. Due to the temperature gradient generated between the near and far walls during application of the process, the residual stress state of the far wall is simultaneously improved (lowered in value) or even made compressive, depending on the application, to provide resistance to SCC. In some BWR structural applications, the method has a sufficiently low heat input that the required through-wall temperature gradient for far-wall stress improvement can be obtained even without liquid cooling on the far wall.

The reduced cladding heat input of the disclosed method is produced in part by a travel speed (torch speed) in excess of about 10 inches per minute, for example 15 to 40 inches per minute, more usually 15-30 inches per minute, so that the time in the sensitizing temperature range during weld cooling is insufficient to allow carbides to precipitate on the grain boundaries.

This method of sensitization control is in contrast to the conventional method of heat input control and minimization, where the heating rate (and therefore cooling rate) of the process and the time constant of the material are not taken into account, but only the integrated heat input. The present invention utilizes a dual control on the welding parameters: (1) heat input (controlled as a function of the heat input per unit length of bead), and (2) HAZ cooling rate (controlled as a function of the welding linear speed in the forward direction). Preferably, cross-bead arc oscillation is avoided, since it is counterproductive with respect to maintaining both the required low heat input and high travel speed. The method therefore allows electric-arc based cladding processes to be applied on materials even with very low resistance to thermal sensitization without high risk of sensitization.

In the conventional cladding approach, heat input is simply calculated as the product of the arc amperage times the arc voltage, divided by the arc travel speed. The heating rate and cooling rate are, however, inherently related to each other by virtue of the torch travel speed. Therefore, at sufficiently high travel speeds, the cooling rate can be controlled by selecting a predetermined critical travel speed related to the critical cooling rate for thermal sensitization to occur in a specific material. The critical cooling rate for a selected austenitic material depends primarily on its grain size, carbon content, ferrite content, thermal diffusivity and section thickness. The preferred heat input for the process is less than about 1.5 kJoule/cm, more usually about 0.5 to 1.0 kJoule/cm. The preferred torch speed is greater than approximately 50 cm/min., typically 60-90 cm/min.

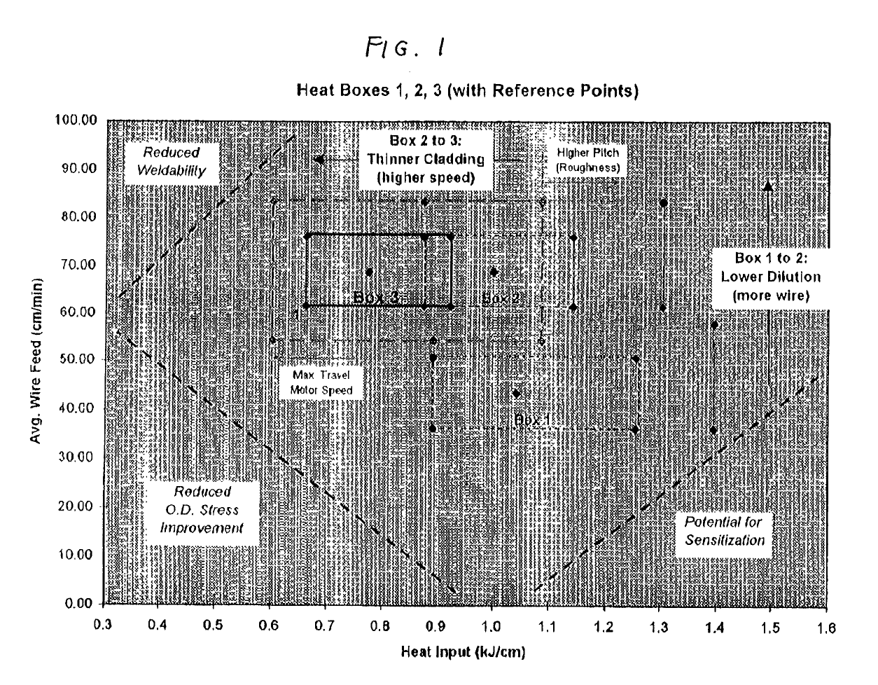

Referring to FIG. 1, there is shown a representation of average wire feed rate versus heat input in relation to Heat Boxes 1, 2 and 3. As used herein, the term “Heat Box” is defined as an operating range of cladding heat input (kJ/cm) as a function of the wire feed rate (cm/min). The center of the Heat Box is the operating point for a desired cladding condition (additional points beyond in their respective claddings).

Heat Box 1 represents a low heat-input, very thin cladding condition suitable for a number of applications, including a 1½ inch ID×¼ inch wall tube made of 300-Series stainless steel, such as Type 304. Heat Box 2 represents a slightly colder, thicker condition for use on marginal base materials (e.g., higher carbon). Heat Box 3 represents an even colder condition for use on more marginal materials (e.g., lower purity, higher carbon). A further refinement may be achieved in a Heat Box 4 condition (located above Heat Box 3) having even higher wire feed, for potential use where additional cladding thickness and its correspondingly lower base-metal dilution) is not as critical to quality as lower heat input.

Referring in more detail to Heat Box 1, a limited range of heat input and wire feed values have been evaluated using the initial process parameters as the approximate center of these ranges. These ranges form the “Heat Box” when plotted against each other, with the intent that all points within the box are expected to have acceptable properties for a selected application, based on having tested only the four corners and the center point of the box. Three additional points beyond the box were also tested for reference, representing higher heat, higher wire, and higher heat combined with higher wire.

For Heat Box 1, the tube material used was Type 304 with 0.073% C., to represent that used in the plant of interest for the first application of the cladding. The cladding pitch (torch axial speed) for all points of Heat Box 1 was not adjusted to control the cladding thickness. The weldability of Heat Box 1 samples was acceptable, and the visual appearance of the samples was excellent.

A battery of tests, including Weldability, Distortion, VT (Visual Test), PT (Penetrant Test), Ferrite, Thickness, Carbon, Palladium, and Sensitization, were performed on the samples of Heat Box 1. Weldability, VT, PT, and thickness were acceptable for all samples representing the box corners or center, but the remainder of the tests did not fully meet their acceptance criteria due to excessive weld penetration and the associated high dilution of the filler by the base metal. The 0.073% C. heat of tube also had a higher level of sulfur than the previous heat, which is believed to be the dominant cause of the significantly higher penetration in the high C material.

Based on the test results of Heat Box 1 conditions, an improved welding condition was planned for evaluation on Heat Box 2. The basis for improvement in the (reduced) penetration was an increase in the filler feed rate combined with an increase in the torch travel rate. The heat input would normally be calculated as reduced with an increase in travel. However, in this case, the arc voltage was increased to maintain a constant heat input and to obtain the secondary benefit of additionally reduced penetration due to the lower arc efficiency associated with higher voltage. The higher travel rate used at this point was made possible due to a high speed travel motor which was installed. The clad thickness was maintained approximately constant, despite the higher feed rate, by virtue of the correspondingly higher travel rates and by variation of the spiral clad pitch. The clad thickness for Heat Box 2 is approximately 0.5 to 0.6 mm, as compared to the initial process value of about 0.3 to 0.4 mm.

Examination of samples produced using the conditions of Heat Box 2 clearly demonstrated a significant improvement in the evaluation parameter results (tested in the same way as Heat Box 1). All of the Heat Box corners and center passed the evaluations for Weldability, Distortion, VT, PT and Thickness. For some of the box points, several of the other properties measured produced borderline results with respect to the acceptance criteria proposed. The Pd measurement was below the acceptance limit for all points, although this condition will be rectified when wire with higher level of filler wire noble metal content is used.

After the sensitization tests were completed for Heat Box 2, it was desired to increase the depth below the tubing inside diameter surface at which sensitization could be seen. The method selected to achieve this benefit was to further increase the torch travel speed and thereby reduce the cladding heat input. The weld current, voltage, and wire feed rates were basically unchanged from the corresponding values used for Heat Box 2. The resulting heat input ranged from 0.6 to 1.1 kJ/cm., with a nominal value of 0.8 kJ/cm.

In order to reduce the thickness resulting from Heat Box 2, which was approximately 0.5 to 0.6 mm, the axial speed was varied for Heat Box 3 to provide a constant cladding thickness for all test and reference points, regardless of the wire feed or travel speed. The axial speed was varied so that the ratio of metal added to the area covered was constant. This ratio is determined by the wire feed, divided by the product of the travel speed times the axial speed. The resulting thickness was very constant for all points of the test box, with a typical thickness of 0.36 mm.

The sensitization measurements for Heat Box 3 were found to be approximately the same or not as good as that of Heat Box 2 on the high carbon, high sulfur heat used. Further analysis led to the hypothesis that this heat of tubing may not be compositionally representative of the heat used at the target plant, especially with respect to its higher sulfur content which leads to increased weld penetration. The increased penetration undesirably leads to increased carbon pickup from the base metal, increased dilution of noble metal in the clad, and less potential for Delta Ferrite formation.

For reference information, three points on Heat Box 3 were selected for a test with the wire feed increased 33% more than was previously used for the nominal values of wire feed. This change significantly increased the Delta Ferrite formed to over 5% in the cladding deposit. The thickness increased from a typical value of 0.36 mm to 0.45 mm, which is within the approximate range allowable for most of the tube locations without subsequent machining. Measurement of the carbon pickup in these modified cladding samples was inconclusive. The weldability was acceptable. However, it was determined that no further increases in wire feed rate could be tolerated (at the extremely low heat input used) without sacrificing the acceptability of the field-application weldability.

A significant improvement was seen in the test results of Heat Box 2 as compared to Heat Box 1, resulting from the reduced dilution which was achieved. Further improvements beyond that of Heat Box 2 were expected when the process parameters were adjusted a small amount using the same parameter trends followed in progressing from Heat Box 1 to Heat Box 2. The weldability and appearance were not adversely affected, based on preliminary tests incorporating these parameter shifts.

Heat Box 3 was created by increasing the travel rate, with an even further reduction in the heat input. The thickness was held constant for all conditions by adjusting the axial speed (bead pitch), according to the travel speed and axial speed. The high sulfur of the base material used for the pipe of these tests is believed to confound the interpretation of the sensitization tests which were performed. Further testing was performed for Heat Box 3 using a high carbon heat with lower sulfur content to clarify the sensitization results. The results of this testing were excellent with respect to all the tests noted above. In particular, no sensitization was found in the portion of the heat-affected zone exposed to the process fluid when in service (the housing ID).

### Cladding Parameters for Heat Box 3

Cladding Parameters for Heat Box 3

| | | Nom- | Mini- | | |
|---|---|---|---|---|---|
| Parameter | Units | inal | mum | Maximum | Tolerance |
| Heat Input | kJ/cm | 0.8 | 0.6 | 1.0 | |
| Wire Feed Rate | cm/min | 70 | 60 | 80 | +/−2% or 2.5 |
| Arc Current | Amps | 85 | 80 | 90 | +/−0.5% or 1.0 |
| Arc Voltage | Volts DC | 11 | 10 | 12 | +/−1% or 0.1 |
| Travel Speed | cm/min | 75 | 65 | 85 | +/−1% or .25 |
| Axial Speed | cm/min | 1.0 | 0.8 | 1.2 | 2% or .01 |
| Arc Gas Type* | % Ar/H₂ | 95/5 | | | |
| Gas Flow Rate* | 1/hr | 570 | | | |
| Wire Diameter* | mm | 0.6 | | | |

*Greater of values shown.
ASSUMPTIONS
1. Testing parameters will not fall outside of the ranges listed in the above table.
2. Testing will use the values of heat input and wire feed shown in the Heat Box.
*NOTE:
The arc gas type, gas flow rate, and wire diameter were held constant at the normal values shown in the above table for the development testing, and gave good cladding results. These parameters will also be held constant for the qualification testing. There is no need to vary these parameters since they have been shown to be appropriate within the relatively low values and narrow ranges of heat input and wire feed which are used within the heat box.

Heat Box 1

| | | | ICMH | | | | | Noble Metal | | Heat Input | | |
|---|---|---|---|---|---|---|---|---|---|---|---|---|
| | | | Mitigation: | | | | | Cladding | | Calculations | | |
| Weld | PP | BP | PC | BC | Av.C | PV | BV | Av.V | P-WFS | BWFS | Av.WFS | Tvl.Sp. |
| No.* | (s) | (s) | (A) | (A) | (A) | (V) | (V) | (V) | (in/min) | (in/min) | (in/min) | (in/min) |
| 64 NM | 0.05 | 0.02 | 103 | 30 | 82.14 | 9.2 | 9.2 | 9.20 | 20 | 0 | 14.29 | 20 |
| 62 NM | 0.05 | 0.02 | 107 | 30 | 85.00 | 10.0 | 10.0 | 10.00 | 20 | 0 | 14.29 | 16 |
| 63 NM | 0.05 | 0.02 | 107 | 30 | 85.00 | 10.0 | 10.0 | 10.00 | 28 | 0 | 20.00 | 16 |
| 65 NM | 0.05 | 0.02 | 103 | 30 | 82.14 | 9.2 | 9.2 | 9.20 | 28 | 0 | 20.00 | 20 |
| 61 NM | 0.05 | 0.02 | 105 | 30 | 83.57 | 9.5 | 9.5 | 9.50 | 24 | 0 | 17.14 | 18 |
| 69 NM | 0.05 | 0.02 | 114 | 30 | 90.00 | 10.5 | 10.5 | 10.50 | 20 | 0 | 14.29 | 16 |
| 70 NM | 0.05 | 0.02 | 114 | 30 | 90.00 | 10.5 | 10.5 | 10.50 | 32 | 0 | 22.86 | 16 |
| 71 NM | 0.05 | 0.02 | 103 | 30 | 82.14 | 9.2 | 9.2 | 9.20 | 30 | 0 | 21.43 | 20 |

Heat Box 2

| Weld | PP | BP | PC | BC | Av.C | PV | BV | Av.V | P-WFS | BWFS | Av.WFS | Tvl.Sp. | Axial S |
|---|---|---|---|---|---|---|---|---|---|---|---|---|---|
| No.* | (s) | (s) | (A) | (A) | (A) | (V) | (V) | (V) | (in/min) | (in/min) | (in/min) | (in/min) | (in./min |
| 99 NM | 0.05 | 0.02 | 105 | 30 | 83.57 | 10.2 | 10.2 | 10.2 | 34 | 0 | 24.29 | 23 | 0.24 |
| 100 NM | 0.05 | 0.02 | 115 | 30 | 90.71 | 11.2 | 11.2 | 11.2 | 34 | 0 | 24.29 | 21 | 0.32 |
| 101 NM | 0.05 | 0.02 | 115 | 30 | 90.71 | 11.2 | 11.2 | 11.2 | 42 | 0 | 30.00 | 21 | 0.30 |
| 102 NM | 0.05 | 0.02 | 105 | 30 | 83.57 | 10.2 | 10.2 | 10.2 | 42 | 0 | 30.00 | 23 | 0.24 |
| 103 NM | 0.05 | 0.02 | 110 | 30 | 87.14 | 10.7 | 10.7 | 10.7 | 38 | 0 | 27.14 | 22 | 0.28 |
| 104 NM | 0.05 | 0.02 | 120 | 30 | 94.29 | 11.7 | 11.7 | 11.7 | 34 | 0 | 24.29 | 20 | 0.32 |
| 105 NM | 0.05 | 0.02 | 120 | 30 | 94.29 | 11.7 | 11.7 | 11.7 | 46 | 0 | 32.86 | 20 | 0.36 |
| 105 NM | 0.05 | 0.02 | 105 | 30 | 83.57 | 10.2 | 10.2 | 46 | 0 | 32.86 | 23 | 23 | 0.24 |

Heat Box 3

| Weld | PP | BP | PC | BC | Av.C | PV | BV | Av.V | P-WFS | BWFS | Av.WFS | Tvl.Sp. | Axial S |
|---|---|---|---|---|---|---|---|---|---|---|---|---|---|
| No.* | (s) | (s) | (A) | (A) | (A) | (V) | (V) | (V) | (in/min) | (in/min) | (in/min) | (in/min) | (in./min |
| '122 NM | 0.05 | 0.02 | 110 | 30 | 87.14 | 10.7 | 10.7 | 10.7 | 38 | 0 | 27.14 | 28.4 | 0.406 |

Heat Box 3

| Weld | PP | BP | PC | BC | Av.C | PV | BV | Av.V | P-WFS | BWFS | Av.WFS | Tvl.Sp. | Axial S |
|---|---|---|---|---|---|---|---|---|---|---|---|---|---|
| No.* | (s) | (s) | (A) | (A) | (A) | (V) | (V) | (V) | (in/min) | (in/min) | (in/min) | (in/min) | (in./min |
| 123 | 0.05 | 0.02 | 105 | 30 | 83.57 | 10.2 | 10.2 | 10.2 | 34 | 0 | 24.29 | 30.4 | 0.339 |
| '124 | 0.05 | 0.02 | 115 | 30 | 90.71 | 11.2 | 11.2 | 11.2 | 34 | 0 | 24.29 | 26.0 | 0.397 |
| '125 | 0.05 | 0.02 | 115 | 30 | 90.71 | 11.2 | 11.2 | 11.2 | 42 | 0 | 30.00 | 26.0 | 0.490 |
| '127 | 0.05 | 0.02 | 110 | 30 | 87.14 | 10.7 | 10.7 | 10.7 | 38 | 0 | 27.14 | 28.4 | 0.406 |
| '128 | 0.05 | 0.02 | 100 | 30 | 80.00 | 9.7 | 9.7 | 9.7 | 46 | 0 | 32.86 | 30.4 | 0.459 |
| '129 | 0.05 | 0.02 | 100 | 30 | 80.00 | 9.7 | 9.7 | 9.7 | 30 | 0 | 21.43 | 30.4 | 0.299 |
| '130 | 0.05 | 0.02 | 120 | 30 | 94.29 | 11.7 | 11.7 | 11.7 | 30 | 0 | 21.43 | 24.0 | 0.379 |
| '131 | 0.05 | 0.02 | 120 | 30 | 94.29 | 11.7 | 11.7 | 11.7 | 46 | 0 | 32.86 | 24.0 | 0.581 |
| '132 | 0.05 | 0.02 | 110 | 30 | 87.14 | 10.7 | 10.7 | 10.7 | 51 | 0 | 36.43 | 28.4 | 0.406 |
| '133 | 0.05 | 0.02 | 115 | 30 | 90.71 | 11.2 | 11.2 | 11.2 | 42 | 0 | 30.00 | 26.0 | 0.490 |
| '134 | 0.05 | 0.02 | 100 | 30 | 80.00 | 9.7 | 9.7 | 9.7 | 62 | 0 | 44.29 | 30.4 | 0.459 |
| '135 | 0.05 | 0.02 | 105 | 30 | 83.57 | 10.2 | 10.2 | 10.2 | 56 | 0 | 40.00 | 30.4 | 0.419 |
| '136 | 0.05 | 0.02 | 110 | 30 | 87.14 | 10.7 | 10.7 | 10.7 | 38 | 0 | 27.14 | 28.4 | 0.406 |
| '137 | 0.05 | 0.02 | 115 | 30 | 90.71 | 11.2 | 11.2 | 11.2 | 34 | 0 | 24.29 | 26.0 | 0.397 |
| '138 | 0.05 | 0.02 | 115 | 30 | 90.71 | 11.2 | 11.2 | 11.2 | 34 | 0 | 24.29 | 26.0 | 0.397 |
| '139 | 0.05 | 0.02 | 115 | 30 | 90.71 | 11.2 | 11.2 | 11.2 | 34 | 0 | 24.29 | 26.0 | 0.397 |

When a conventional corrosion-resistant cladding (CRC) is applied to an area of an SCC-susceptible substrate, the area covered can be protected from corrosion. However, the adjacent HAZ created by the cladding process may then become thermally sensitized and consequently subject to SCC. This potential for sensitization is compounded when cladding thin materials which have only a low self-heat sinking ability and correspondingly limited cooling rate. In the method of the invention, the thickness and heat capacity of the material are taken into account in determining the travel speed and resulting heat input so that the temperature profile approaches that of a substrate having semi-infinite thickness. Therefore, heat buildup is sufficiently controlled to maintain the critical cooling rate and therefore prevent SCC even in very susceptible (high-carbon, thin) materials.

The higher travel speed characterizing the present method provides a steeper temperature gradient through the thickness of the substrate, and allows a faster HAZ cooling rate to occur. Conventional cladding practice for heat input control minimizes the heat input (amps×volts) per unit length of a cladding pass. As the heat input is decreased, so is the molten pool size, making the filler feed into the reduced size pool more difficult and ultimately impractical. In the present method, the heat input may be held constant or even increased to enlarge the pool size in order to make the filler feeding more tolerant to misalignment or other common problems. As the weld power is increased, the pool becomes increasingly superheated above the melting temperature so as to simultaneously increase the temperature gradient at the leading edge of the pool and the maximum practical wetting rate (above which lack-of-fusion may occur). As the maximum wetting rate increases, the travel speed may be increased so as to keep the heat input constant or reduced. A benefit of this scheme is improved thermal melting efficiency.

As described above, a first benefit of the present invention is to deposit a SCC-resistant cladding on susceptible materials, without generating a sensitized region either at its edges or underneath the cladding. A second important benefit is to deposit the cladding with noble metal addition acting as a catalyst for more efficient recombination of oxygen and hydrogen so that the cladding itself, as well as the underlying material's HAZ, is fully resistant to SCC, even when applied as a single thin (diluted) layer. A third benefit of the process, when applied to the inside diameter of a pipe or tube, is the ability to improve the residual stress on the outside diameter of the pipe, either when the OD is liquid cooled (the preferred condition) or in a gas environment. This stress improvement prevents material that is susceptible to SCC from cracking on either the corrosion-resistant clad ID, or the low-stress OD. Conventional welding on the ID of a pipe requires liquid cooling (such as water) on the OD, since the speed is too slow to prevent the heat from penetrating through the full wall thickness, without the increased heat sinking of the cooling water. With the conventional water cooled method, known as “heat-sink” welding, stress improvement can be achieved. However, due to the relatively slow thermal kinetics (slower torch speed), sensitization is more likely because of the longer time during which the cooling HAZ is within the sensitization temperature range.

In the present method, the heat input is kept low enough (relative to the high torch travel speed and thermal diffusivity of the substrate) that a sufficient through-wall temperature distribution is generated and results in an elastic elongation of the outside portion of the wall and a plastic compression of the inside portion of the wall, while at elevated temperature. Upon cooling, the compressed inner portion further contracts relative to the outer portion due to the greater temperature change required for it to return to ambient temperature. The contraction of the hot inner portion is restrained by the colder outer portion. Thus, after cooling, the inner portion is in tension while the outer portion is in compression (or in low tension, depending on the initial stress state and the degree of OD cooling). A force balance is thereby maintained between the inner and outer portions of the wall thickness.

The heat input (measured as kjoules per length of weld bead deposited) for the present method is several factors to an order-of-magnitude lower than conventional low heat input TIG cladding (approximately 10-20, or even greater in cases where heat input is not severely limited). It is also significantly lower than the lowest heat-input laser cladding process. The travel speed of the torch is approximately an order-of-magnitude greater than that of known processes for weld cladding of reactor internals, which greatly improves the HAZ cooling rate and the corresponding time reduction within the thermal-sensitization temperature range. Other types of thermal damage, such as weld shrinkage distortion, are also significantly reduced or eliminated.

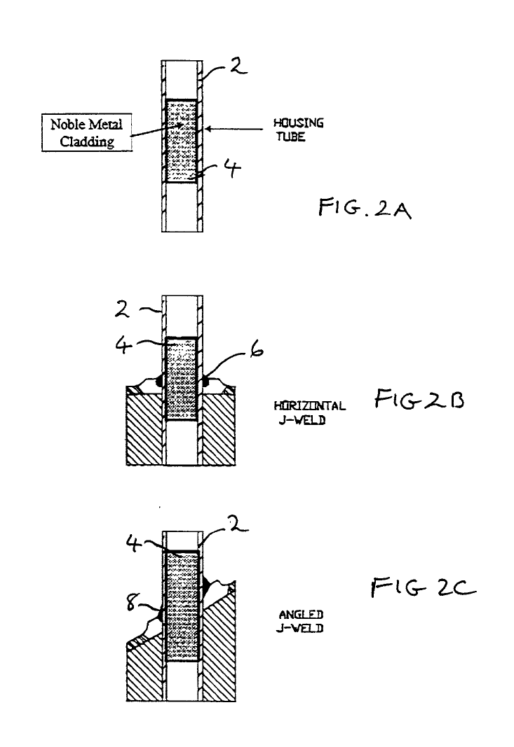

FIGS. 2A, 2B and 2C illustrate cross-sectional side elevations of mock-ups of various monitor housing and vessel penetration configurations used for noble metal cladding process development. FIG. 2A shows a housing tube 2 with a noble metal cladding 4 located internally. FIG. 2B depicts a typical horizontal J-weld 6 about a housing tube 2 with cladding 4 on the inside of the tube. FIG. 2C depicts a typical angled J-weld 8 about a housing tube 2 with cladding 4 on the inside of the tube. Control rod drive housings can have similar configurations, but with typically larger housing diameter (approx. 6 inch).

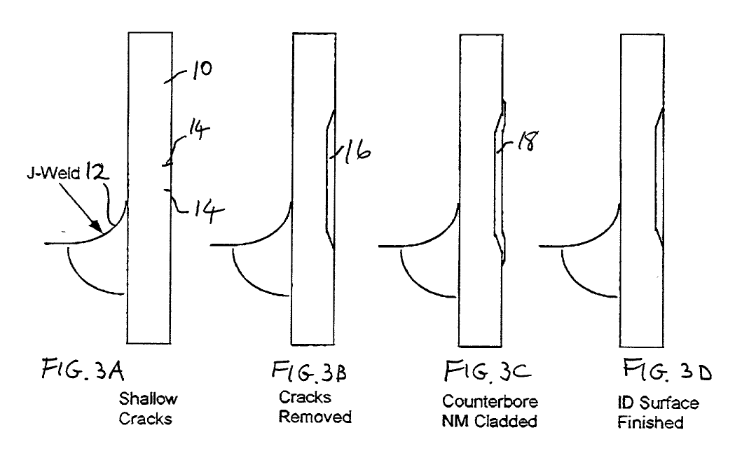

FIGS. 3A-3D illustrate the application of a noble metal cladding to wall-thickness structural repair of a vessel. FIG. 3A shows the wall 10 of the vessel with a J-weld 12 and shallow cracks 14. In FIG. 3B, the cracks have been removed to produce a recessed portion 16. In FIG. 3C the cladding 18 has been welded onto the inside surface of the wall and in FIG. 3D the inside surface is finished by grinding.

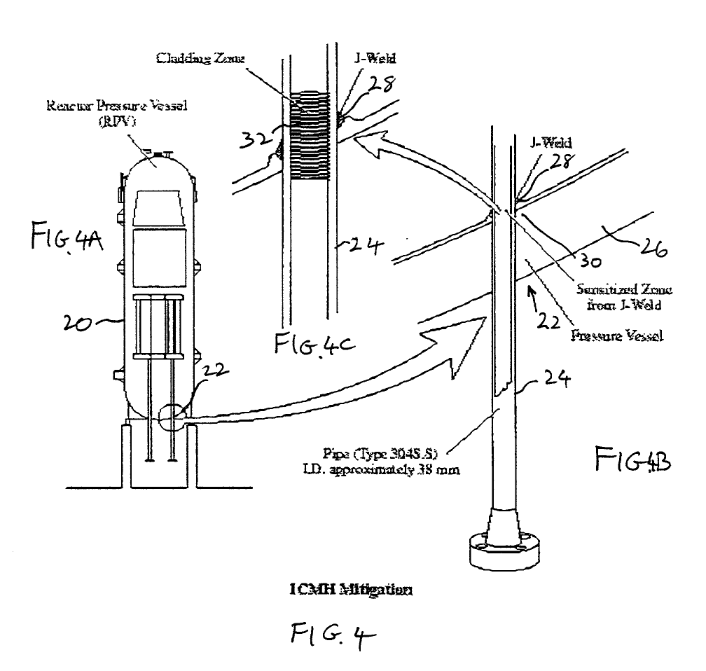

FIGS. 4A-4C are schematic views showing an application of the present invention through a reactor pressure vessel wall. FIG. 4B is an enlarged view of the lower region 22 of the pressure vessel 20, where a housing 24 extends through the wall 26 of the vessel. A J-weld appears at 28 close to a sensitized zone 30 from the J-weld. FIG. 4C is an enlarged view of the region of the J-weld 28 shown in FIG. 4B, and showing the cladding 32.

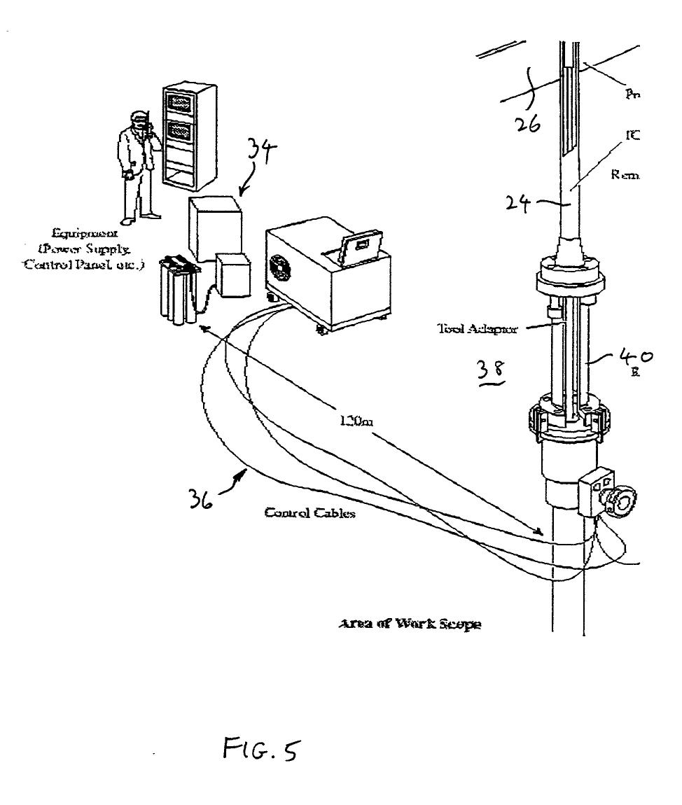

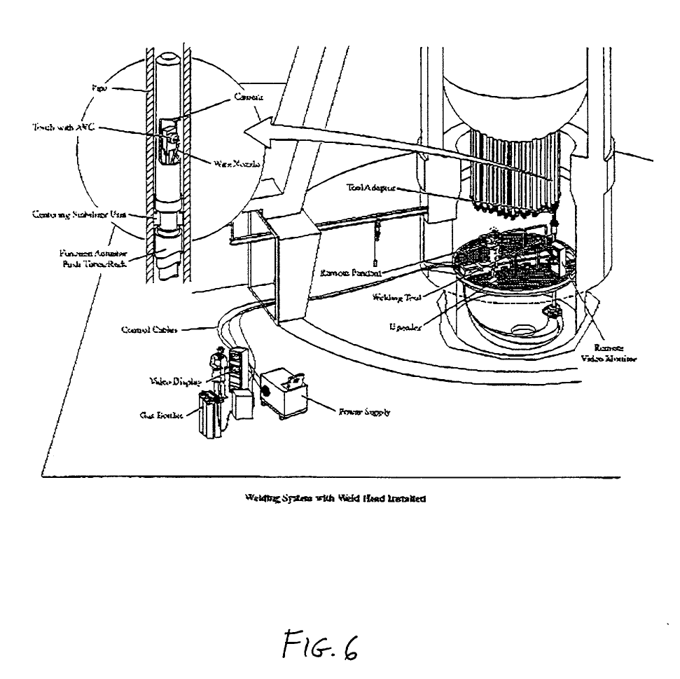

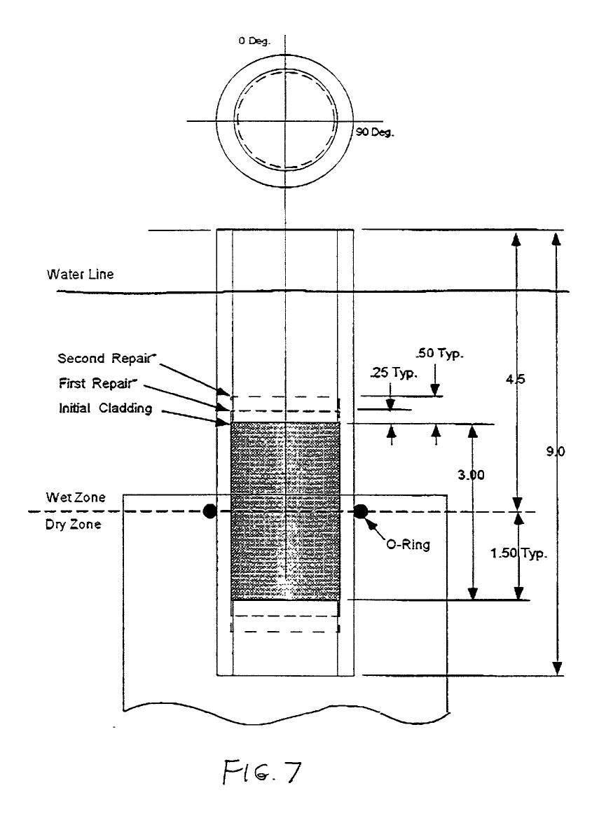

FIG. 5 is a schematic of a weld cladding system showing individual power supply and control components 34 connected by cables 36 to a work zone 38. A tool adapter 40 is connected to a housing 24 which extends through the wall 26 of the vessel.

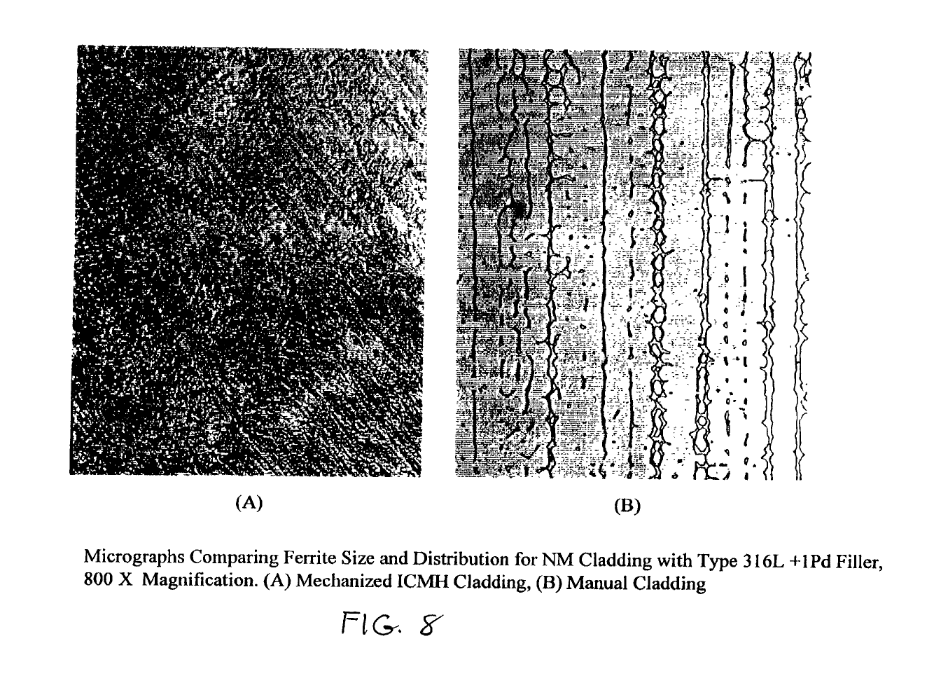

FIG. 6 is a cutaway view of a welding system installed for under-vessel application of the cladding methodology of the present invention.

FIG. 7 is a schematic layout for successive cladding repairs showing the method used to prevent process fluid exposure to multiple heat-affected zones.

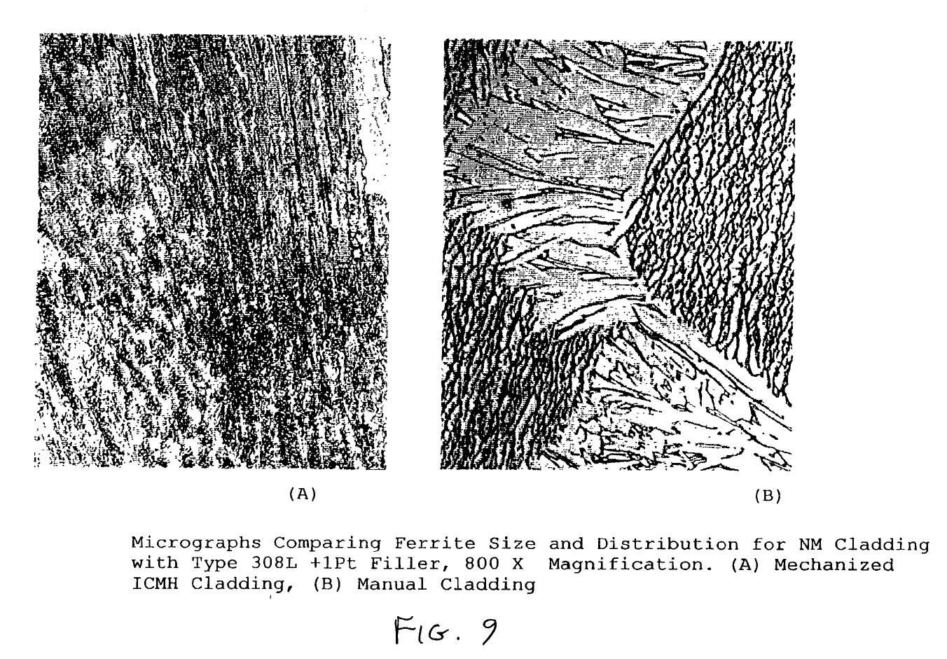

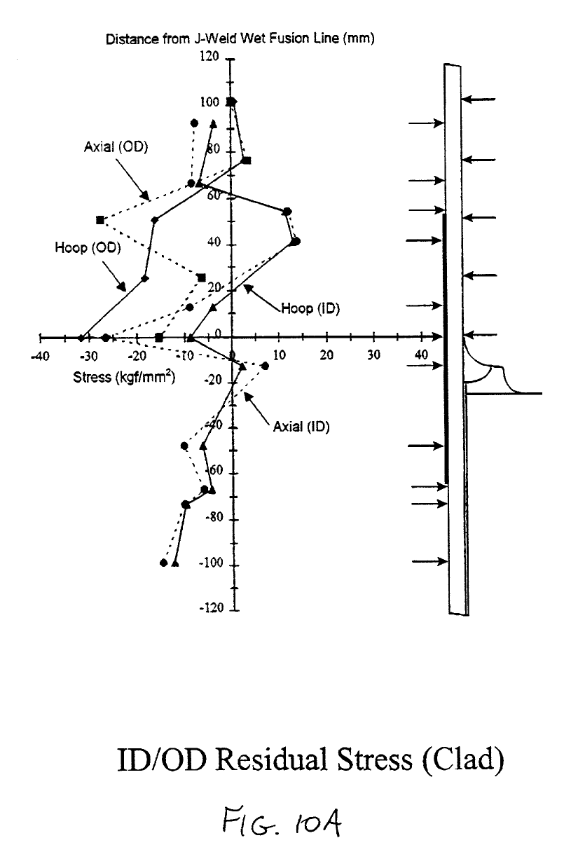

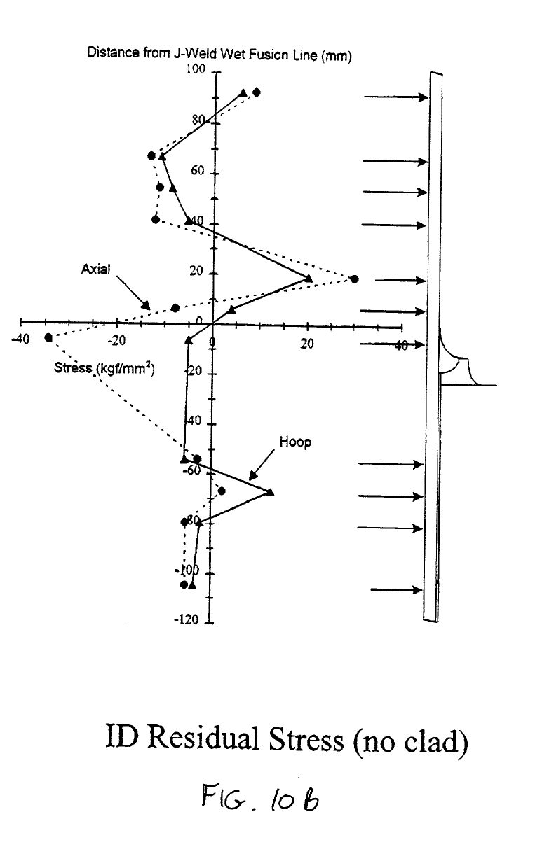

FIGS. 8A and 8B are micrographs comparing Ferrite size and distribution for noble metal cladding with Type 316L+1 Pd filler; 800×magnification. FIG. 8A is a micrograph for mechanized ICMH cladding; FIG. 8B is a micrograph for manual cladding. FIGS. 9A and 9B are micrographs comparing Ferrite size and distribution for noble metal cladding with Type 308L+1 Pd filler; 800×magnification. FIG. 9A is for mechanized ICMH cladding, FIG. 9B for manual cladding. These photographs show a striking difference in Ferrite size (and corresponding surface area and uniformity) between the uniquely low heat-input ICMH micro-TIG cladding process (for Heat Box 3 in this instance), and a conventional heat-input manual TIG welding process applied with the same fillers. Both the 316L and 308L SS filler alloys show this large difference. The unexpected result is that the fineness of the Ferrite morphology more than compensates for the lower-than-typical volume percentages of ferrite in the ICMH cladding, with respect to the high SCC resistance.

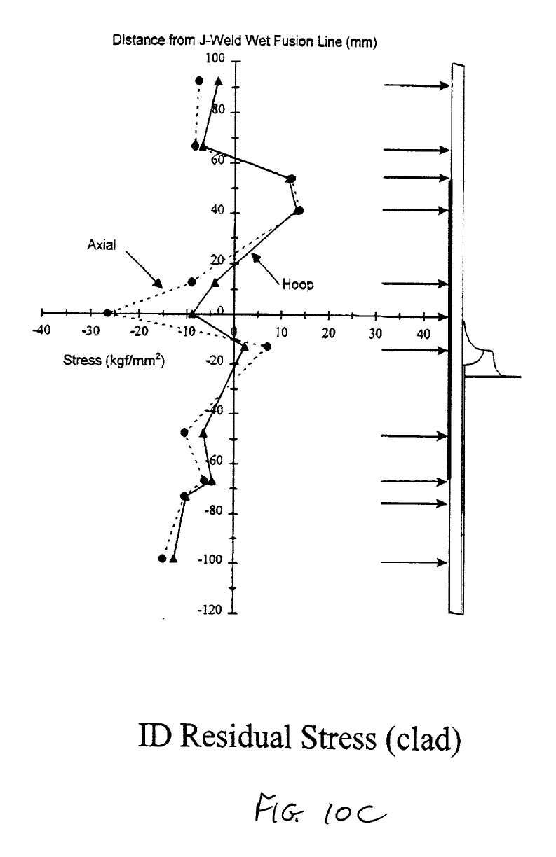

FIGS. 10A-10C are stress plots respectively showing ID/OD residual stress (clad), ID residual stress (no clad) and ID residual stress (clad) as a function of the distance from the J-weld wet fusion line (mm).

The apparatus of the invention has the capability to deposit the cladding in a single, continuous spiral motion.

A variation of the apparatus, which is suitable for cladding vessel penetrations such as nozzles and stub-tubes, allows the local heat input to be tailored according to need, in general depending in part on the elevation in the tube with respect to the J-weld. In particular, for vessel bottom head penetrations into a flooded vessel, the lower portion of the penetration has a dry OD, and less heat is required to deposit a cladding without risk of lack-of-fusion defects, compared to the externally water-cooled upper portion. The method and apparatus of the present invention adjust the cladding local heat input (via a change in the arc voltage, current, and/or travel speed) as a function of elevation.

When applying a cladding to an In-Core Monitor Housing (ICMH) or similar tube where the upper portion is water cooled on the OD and the lower portion is dry on the OD (with a “J-weld” between the tube and vessel bottom separating the wet and dry zones—shown in FIG. 4), the preferred progression of the cladding is from bottom to top. This progression enables the first (lower edge) bead to be deposited before any heat buildup begins, in order to keep its HAZ as cold and small as possible to prevent sensitization at the ID surface which is exposed to the process fluid when in service. The final (upper edge) bead does not have as significant a heat buildup as the initial bead, since the upper portion is water cooled on the OD. Therefore, the potential for sensitization of the exposed HAZ (especially the lower one) is reduced.

In cases where the disclosed cladding thickness is not a limitation, multiple layers may be applied in order to compensate for dilution of the deposit by the base material, or to provide increased structural reinforcement to the clad component. In other cases, where the base material is sensitive to distortion, hot-cracking, or other thermally induced defects during conventional cladding or welding methods, the present method can be used to build up a layer to provide improved component dimensions or metallurgical properties.

One important case for nuclear reactor internals is fusion welding on materials having been exposed to high neutron fluxes, causing the formation of helium in the material structure. The presence of even low amounts of helium is known to make fusion welding on these materials very difficult without the occurrence of helium-induced hot cracking. After one or more layers are applied using the present invention, the conventional weld cladding or joining processes can be applied over the disclosed cladding without risk of cracking or other thermal damage to the base material.

Changes to the travel speed are preferably made with corresponding changes to the wire feed rate, so as to keep the cladding thickness constant. The changes may be either preprogrammed, or changed during the course of the welding, depending on feedback from weld bead performance sensors, such as bead width/height monitors. This type of feedback control can also take changes of the base material composition into account, such as increases in the sulfur content which decrease bead width and increase penetration into the base metal. At very low heat inputs where the bead width is already narrow, further reductions in bead width negatively affect weldability, since wire feed aiming is less reliable into a narrower bead. Increases in weld penetration negatively affect the corrosion performance of the cladding, since the dilution of the filler by a SCC-prone base material (such as a high carbon or low purity grade of material), in turn, makes the cladding more prone to SCC.

The present method employs a test to determine that SCC does not occur in accelerated-life specimen testing (as demonstrated by bent-beam sample testing), and that sensitization does not occur at the exposed edges of the cladding (as demonstrated by American Society of Testing and Materials (ASTM) A262, Practice “A” microstructural examination on clad samples). The present invention results in a significant improvement in SCC resistance, relative to that obtained using existing techniques, due to its ability to pass a more stringent acceptance criterion, while being able to be deposited in an extremely thin single layer which for existing practices leads to more cladding dilution and lower SCC resistance.

The welding tool deposits a very thin, low-heat input cladding on the ID of 2-inch nominal size, Sch 80 Type 304 SS pipe. The pipe housing is currently welded as a pass-through penetration into a nuclear reactor pressure vessel bottom head (see FIG. 4), and is fitted internally with instrumentation during plant service. The nominal ID is 1.50 inch (0-25 inch wall). The housing is in the vertical orientation and the OD is surrounded by water. The upper end will be temporarily plugged during the cladding; the lower end has a removable bolted flange attached. Access to the ID is from the housing lower end only.

The area to be cladded is in the vicinity of an existing OD J-weld which may have caused radial (inward or outward) distortion and radial housing-axis offset up to 0.10 inch (2.6 mm), resulting in a specified worst-case local minimum diameter of 1.386 inch (35.2 mm). The radial inward distortion and axis offset may occur simultaneously as ID eccentricity on the downhill side of the outer penetration locations. On the uphill side, the radial distortion occurs in the outward direction, which should not interfere with the weld head when fit within the housing.

The weld deposit region may be continuously viewed and recorded by high resolution color video camera before, during, and after welding using the same equipment setup, with lighting adjustments as required. No welding head cables, including camera cables, may he twisted during the welding progression to accommodate the continuous rotation (which may exceed approximately 100 revolutions in a single layer, such as during possible housing wall repair). The welding control system is generally capable of restarting the welding progression remotely (without the torch being withdrawn from the housing) if an unplanned stop occurs during the deposition of a weld layer.

The cladding maximum length is typically of the order of 6 inches (150 mm), and is generally deposited as a continuous downward spiral without stopping. The minimum cladding length is usually of the order of 3.5 in. (90 mm). The cladding thickness is generally between about 0.0079 and 0118 in. (0.2 and 0.3 mm) in the as-deposited condition. The filler wire is typically fed from the leading side of the weld pool, within a 30 degree maximum angle from the forward travel direction.

The wire spool usually rotates with the weld torch. The wire drive may be of the four-wheel type and incorporate a grooved (rather than toothed) type of wheel. A three-wheel, adjustable wire straightener may be used ahead of the four-wheel drive assembly.

Both the rotation and translation (axial direction) axes may have digital position readouts for continuous for torch tip position monitoring and recording, relative to the housing flange face (or spacer to flange, when used). One set of readouts can be located at the remote control pendant, and a duplicate (redundant) set may be located at the welding power supply.

Cladding Parameter Ranges

| | |
|---|---|
| Surface prep: Flapping/honing | Wire size: 0.023 to 0.025 in. |
| Arc current: 30 to 130 A | Travel speed: 15 to 20 ipm at work |
| Current type: Pulsed level | Axial speed: 0.10 to 0.25 ipm |
| Arc volts: 8.4 to 10.2 V | Filler type: ER 316L |
| Voltage sensing: Primary only | Wire feed: 15 to 30 ipm |

Repair of the housing ID in the region to be cladded is generally achieved by removing defective material up to ⅛ in. (3.175 mm) of the wall (using tooling provided by others) and replacing this material with a single or multiple-layer weld spiral deposit. The number of repair welding layers required will depend on the thickness of the material removed. The thick-type of repair weld layer will tie into the edges of the cylindrical repair cavity (counterbore). The counter-bore edges will be sloped approximately 3/1 to the housing ID. The repair parameters will be approximately the same as those for cladding, except that the axial speed will be reduced to increase the deposit thickness of each layer, with a goal of approximately 1/16 inch max. thickness per layer, and a maximum of two short repair layers followed by a thin, full-length cladding.

The invention will now be described with reference to the following non-limiting example.

### EXAMPLE

Cladding tests were performed with the purpose of demonstrating process feasibility for a wire-feed TIG method applied to the inside of a 1½-inch-ID pipe. Since time did not permit, preliminary scoping tests were not performed. The initial parameters were based on FineLine Welding “multiple cover pass” parameters which were able to produce thin, low-heat input cladding. A customer Critical To Quality (CTQ) attribute was to maintain the heat input to approximately 1 kJ/cm, so the process was modified to successfully meet this goal. A subsequent CTQ was to maintain the cladding thickness to approximately 0.3 mm, which was also met, but with a decrease in weldability. A significant limitation for reducing the heat input was due to the equipment travel speed, which could be increased only to 16.5 inch/min. This travel rate is several factors greater than conventional TIG, and is reliable at low arc current only with a hotter, reducing arc as-is achieved with the hydrogen/argon plasma-forming gas mixtures which were chosen for this work.

Scoping tests were made with available Pd-doped Type 316L filler in an attempt to have a filter containing noble metal in the demonstration samples. However, the amount of Pd was only 0.3%. It was understood however that about 1% noble metal would be required in the welding wire to achieve full catalytic effect, while compensating for dilution of the deposit by the base material, and that such material would be made available later, The 0.3% Pd content did not have a noticeable effect on weldability, relative to prior experience with undoped cladding. The tube used for these tests was typically Sumitomo Type 304 having approximately 0.001% carbon (C) content. A single test on a well-characterized archive heat of 4-in diameter pipe containing 0.068% C. (a heat known to readily sensitize and crack by intergranular stress corrosion cracking (IGSCC)) was also performed to check the high carbon condition for sensitization. Sensitization is detected through microscopic examination as precipitation of continuous carbides at the grain boundaries, and is an important prerequisite for IGSCC. This clad tube test was performed with stagnant water backing in the clad area to represent plant conditions.

Based on metallography at both the edge and underlying portions of the heat-affected zone (HAZ), no thermal sensitization was noted in any of the 2 inch or 4 inch pipe test samples (no sensitization tests were performed at the time on samples made without water backing on re-annealed material to simulate the dry, creviced zone below the J-weld root). The cladding thickness was adjusted through a number of trials to be approximately 0.3 mm thick, and in this condition the depth of penetration was very low relative to other TIG cladding practices-

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of joining a first metal to a surface of a second metal at a region susceptible to stress corrosion cracking, comprising welding said first metal to said surface of said second metal under conditions of low heat input to achieve reduced thermal sensitization.

2. A method according to claim 1 wherein said first metal is cladding and said second metal is a component of a nuclear reactor.

3. A method according to claim 2 wherein said welding is effected using a welding torch.

4. A method according to claim 3 wherein said welding torch travels at a speed in excess of 10 inches per minute.

5. A method according to claim 3 wherein said welding torch travels at a speed of 15 to 30 inches per minute.

6. A method according to claim 1 wherein said heat input is less than 1.5 kJoules per cm.

7. A method according to claim 6 wherein said heat input is in the range of 0.5 to 1.0 kjoules per cm.

8. A method according to claim 1 wherein said welding is carried out using a filler material.

9. A method according to claim 8 wherein said filler material comprises a noble metal.

10. A method according to claim 9 wherein said noble metal is selected from the group consisting of palladium, platinum, rhodium and combinations thereof.

11. A method according to claim 9 wherein said noble metal is present in said filler material in an amount of 1% by weight or less.

12. A method according to claim 9 wherein said noble metal is present in said filler material an amount of about 0.25 to 0.75% by weight.

13. A method according to claim 1 wherein said welding is carried out over a period of time such that such that the metal temperature during weld cooling is insufficient to allow carbide formation on grain boundaries.

14. A method according to claim 1 wherein said welding is carried out over a period of time in the sensitizing range such that such that the metal temperature during weld cooling is insufficient to allow carbide formation on grain boundaries.

15. A method according to claim 1 wherein said welding is carried out over a period of time to form a fine microstructure of Delta Ferrite.

16. A method of joining a first metal to a surface of a second metal at a region susceptible to stress corrosion cracking, comprising welding said first metal to said second metal under conditions of low heat input to achieve reduced residual stress on said surface and near surface.

17. A method according to claim 13, wherein said first metal has a far surface which is water cooled.

18. A method according to claim 13, wherein said first metal has a far surface which is air cooled.

19. A method according to claim 13, wherein said first metal has a far surface which exhibits reduced residual stress.

20. A method according to claim 13, wherein said first metal has a near surface which exhibits reduced residual stress.

21. A method according to claim 13, wherein said first metal is adjacent to a near surface of said second metal.

22. A method according to claim 13, wherein said second metal is adjacent to a near surface of said first metal.
